(19) United States
(12) Patent Application Publication
(10) Pub. No.: US 2021/0382764 A1
(43) Pub. Date: Dec. 9, 2021

(54) COMPARISONS OF APPLICATION PROGRAMMING INTERFACE INTERACTIONS TO DETERMINE COMPATIBILITIES

(71) Applicant: Hewlett-Packard Development Company, L.P., Spring, TX (US)

(72) Inventors: Mauricio Coutinho Moraes, Porto Alegre (BR); Daniele Antunes Pinheiro, Porto Alegre (BR); Victor Castro, Porto Alegre (BR); Claudio Andre Heckler, Porto Alegre (BR)

(73) Assignee: Hewlett-Packard Development Company, L.P., Spring, TX (US)

(21) Appl. No.: 17/285,510

(22) PCT Filed: Dec. 5, 2018
(86) PCT No.: PCT/US2018/063989

§ 371 Date: Apr. 15, 2021

(51) Int. Cl. G06F 9/54; H04L 29/08; H04L 29/06

(52) U.S. Cl. CPC G06F 9/541; H04L 67/40; H04L 67/2823

(57) ABSTRACT

An example of a computer-readable medium storing machine-readable instructions. The instructions may cause a processor to identify sets of related interactions with application programming interfaces (APIs). The instructions may cause the processor to compare the sets of related interactions to determine compatibility of the APIs.

### BACKGROUND

Updates to an application may include updates to an application programming interface (API) used to access the application. A newer version of the application may be compatible with an older version, depending on what changes may have been made to the API or internal functioning of the application.

### BRIEF DESCRIPTION OF THE DRAWINGS

Various examples will be described below referring to the following figures:

FIG. 1 shows a computer system for comparing API interactions in accordance with various examples;

FIG. 2 shows a method of identifying and comparing related interactions with APIs in accordance with various examples;

FIG. 3 shows a method of applying a set of rules to identify related calls of versions of an API in accordance with various examples; and

FIG. 4 shows a method of selecting and comparing requests to APIs.

### DETAILED DESCRIPTION

When an application is updated to a new version, its API may change. Some changes to an API lead to compatibility issues, where interactions with the application that worked under a previous version no longer work, or work differently, under a new version. While some compatibility changes are intentional, some changes to an application may unintentionally create compatibility issues.

By comparing the API interactions between different versions of an application, compatibility issues may be detected before a new version of the application is released. Actual client interactions with the application may be captured and the requests and responses compared against interactions with an application under development. Some differences in the requests and responses may be benign and not affect compatibility. An incompatibility may be detected and the results saved or an indication provided to a developer of the application.

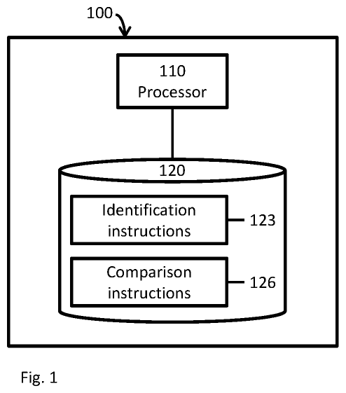

FIG. 1 shows a computer system 100 for comparing API interactions in accordance with various examples. Computer system 100 includes a processor 110 and storage 120. Storage 120 comprises identification instructions 123 and comparison instructions 126.

The computer system 100 may include a server, a laptop or desktop computer, a tablet, or another electronic device. The processor 110 may comprise a microprocessor, a microcomputer, a microcontroller, a field programmable gate array (FPGA), or discrete logic to execute machine-readable instructions. The storage 120 may include a hard drive, solid state drive (SSD), flash memory, electrically erasable programmable read-only memory (EEPROM), or random access memory (RAM). The processor 110 may be coupled to the storage 120, such as via a bus. The processor 110 may execute the identification instructions 123 and comparison instructions 126 stored in storage 120 or implement the methods discussed in connection with the other figures discussed herein.

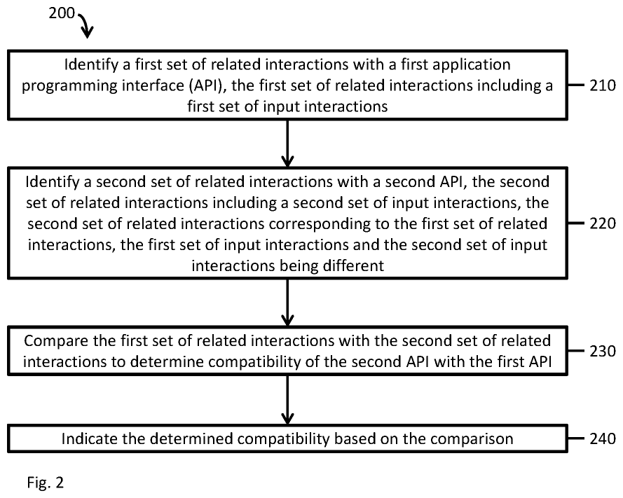

FIG. 2 shows a method 200 of identifying and comparing related interactions with APIs in accordance with various examples. The method 200 includes identifying a first set of related interactions with a first application programming interface (API), the first set of related interactions including a first set of input interactions (210). The method 200 includes identifying a second set of related interactions with a second API, the second set of related interactions including a second set of input interactions, the second set of related interactions corresponding to the first set of related interactions, the first set of input interactions and the second set of input interactions being different (220). The method 200 includes comparing the first set of related interactions with the second set of related interactions to determine compatibility of the second API with the first API (230). The method 200 includes indicating the determined compatibility based on the comparison (240).

Interactions with an API of an application may be recorded. This functionality may be provided as part of the application itself. The application may have a setting that enables logging of the API interactions. The application may log the calls into the application along with the values passed in as parameters. The results or responses from the application may also be recorded. In various examples, the logging may be performed externally to the application. For example, a hypertext transfer protocol (HTTP) proxy may be used in combination with a web application. The HTTP proxy may be external to the web application and capture the HTTP calls and responses from the web application.

Interactions with the API may be related interactions. Related interactions may include a set of interactions to exercise a specific functionality of the application. The calls within a set of related interactions may be called related calls. A developer may define which interactions are related interactions for an API. For example, a developer may define that a “setAttribute” call followed by a “commitChanges” call are related interactions. Interactions may include input interactions and output interactions. Input interactions initiate an interaction with the API, for example, calling a function or method of the API. Requesting data from the API may be an input interaction, as it may involve calling a function to request the data. Output interactions include responses such as the API initiating a call-back function registered with the API. Output interactions may be used as part of an asynchronous interface.

If no definition of related interactions is provided, a definition may be created programmatically through analysis of the interactions to identify set of calls used in a specific sequence. If no definition of related interactions is provided, the sets of related interactions may be sets of individual interactions. In various examples, a set of related interactions may include a single interaction with the API. For example, sending an application termination call to close down the application without returning a status value may be a single interaction. In various examples, related interactions may be a single application call and a single response. For example, an application call to request the current time may be one interaction, and the response indicating the current time may be another interaction. In various examples, the call and response may be considered one interaction. For example, when making a function call to a dynamically linked library (DLL), the return value from the function call may be considered part of the same interaction. In contrast, a call may be made into the API that results in some delayed response. For example, a call may be made into a web application to process a data set, which may involve a non-trivial amount of time. The web application may send a response once the processing is complete. After receiving the call, the web application may send a status code or acknowledgement back promptly, followed by the response once the processing is complete. The call, acknowledgement, and response may be one set of related interactions.

In various examples, multiple calls and responses may be one set of related interactions. For example, a configure and commit architecture may be used. Multiple configuration calls may be made, and the configuration may be committed. For example, an application may allow for creating a new entry in a contact list. One call may be used to indicate a new contact is to be created. A second call may be used to supply a name for the contact. A third call may be used to supply a telephone number for the contact. A fourth call may be used to commit the contact, which may save the contact into a database of contacts. If the second call to supply the name supplied an incorrect name, another call could be made before the commit call, in order to correct the name before it is saved to the database. The four calls and responses to the calls may be a set of related interactions.

In various examples, a call may be related to multiple responses. For example, a call may be used to initiate a timer. A response may be provided at the time the timer is set. Another response may be provided to indicate expiration of the timer. The call and two responses may be a set of related interactions.

In various examples, identifying a set of related interactions may include identifying an originating source of a call or a destination of a response. For example, multiple users may be using a web application. One user's interactions may be related to each other, but not related to interactions by a second user, even though they are received by the same web application at overlapping periods of time.

A set of related interactions with one API may be identified for comparison against a second set of related interactions with a second API. The second API may be a different API or a second version of the first API. The second set of related interactions may be identified as corresponding to the first set of related interactions as they use the same function name in both APIs. The calls to the function may use a different number of parameters. For example, both set of related interactions may call the “createContact” function. Both sets of interactions may pass in the string “Bob” as a name parameter. One set of interactions may also pass in a phone number as a parameter. In various examples, the parameters may be relevant to whether interactions correspond to each other. For example, an API may expose a “getString” function that takes an enumerated type in the form of a number as a parameter. The retrieved string may depend on what parameter was passed in. For example, passing in the number one may indicate a name is to be retrieved, but passing in the number two may indicate an address is to be retrieved. While comparing “getString” calls from different APIs that use different numbers may be useful for some indication of compatibility, considering the number and comparing “getString” calls from the different APIs that both use the number 1 as the parameter may provide a better comparison in determining compatibility. A developer may indicate interactions where the value of a parameter should be considered, such as in a configuration file.

An application may have multiple versions. A version may be identified by a textual label or a tag. In various examples, the version may include a version number. The version number may include a major version number and a minor version number. A higher version number may indicate a more recent version of the application. For example, one version number of an application may be 1.0, while another version number may be 2.3. Sub-version numbers may be used, or alphabetical characters, or a combination. Different version numbers may indicate an interface or functionality of the application has changed.

The corresponding sets of related interactions may be different from each other. The calls to the API may use different numbers of parameters and different values for those parameters. The sets of related interactions may be pulled from actual interactions with the APIs. For example, a released version of an application may be in use. The first set of related interactions may be interactions of users with this released version of the application. A second version of the application may be in development. The second set of related interactions may be interactions of the application developers or beta testers with the second version of the application. Even though one set of related interactions may be setting a contact's name to “Bob,” and the other set of related interactions may be setting a contact's name to “John,” they may still correspond to each other and be compared. Thus, the corresponding sets of related interactions may be from the interactions of different users with different computer systems.

The corresponding sets of related interactions may be compared to determine compatibility between two APIs or two versions of an API. Compatibility means that the same set of interactions may be used with both APIs or versions. There are different kinds of compatibility. Backwards compatibility is where interactions developed for an older version of an API still work on a newer version of the API. The newer version may add additional functionality, but still support the interactions supported by the older version. Forward compatibility is another kind of compatibility where older versions work with interactions designed for a newer version. APIs may also be compared for compatibility even if they are not different versions of the same application. Some applications share an API with other applications. For example, a database API may be shared by different database applications. This may allow a user to interface with both database applications in the same way. Each database application may implement additional functionality through its API that is not implemented by the other database, yet still be compatible, as there is a common set of interactions that work with both applications. A newer version of an API may implement additional functionality and still be backwards compatible with an older version of the API.

In various examples, a developer may indicate what kind of compatibility to test for, such as via a setting or a command line parameter. The developer may also indicate methods, interactions, or sets of interactions for which there are known compatibility issues. This may allow the test to suppress errors or warnings regarding those methods, interactions, or sets of interactions.

In various examples, using different parameter types for corresponding interactions may cause a compatibility issue. A compatibility issue may be a specific instance where the two APIs are not compatible. For example, if a “setAge” interaction of one application passes in a string value, but a “setAge” interaction with another application passes in a numeric value, there may be a compatibility issue. However, some applications may have calls with the same name and use overloading of functions to distinguish between the calls. Thus, “setAge” using a string may resolve to a different functionality than “setAge” using a number. In identifying sets of related interactions, it may be useful to identify these variations. For example, if interactions with the first application include the “setAge” call with a string and the interactions with the second application include the “setAge” call with a number and calls with a string, then the second application may be compatible with the first, as the interactions with the first application may still work as interactions with the second application. However, the first application may not be compatible with the second application, as calls to “setAge” with a number may result in an error. Such issues may also arise if a return parameter type is different.

It should be noted that capturing sets of interactions may not capture all interactions supported by an application. Some interactions may never be used or rarely used. Using data of actual customers interacting with the application may inform decisions about releasing a product that breaks compatibility. For example, if the data indicates one in a million customers makes a particular call, it may make better business sense to release a new version that eliminates that call than to continue supporting the call.

In various examples, using different functions, methods, or names for the functions or methods may cause a compatibility issue. For example, one version of an API for a web application may use a GET call and specify a resource path, while a newer version of the API may use a POST call and specify the same resource path. This compatibility issue may be identified when no calls to the newer API show up as corresponding to the GET call for the older API. In such circumstances, it may be possible to analyze the parameters or other information to identify that such a change has occurred.

In various examples, a change in a status code may indicate a compatibility issue. For example, if calling “createContact” on a first version of an API returns a status code of 000, indicating success, seeing a status code of 200 returned from calling “createContact” on a second version of the API may indicate a compatibility issue. Alternatively, it may indicate that a user encountered an error, such as trying to create a duplicate contact or running out of memory. In various examples, collection of multiple calls to “createContact” may be compared. This may allow identification of instances where a change in the status code returned from the call does create a compatibility issue. For example, if creating a duplicate contact previously returned a status code of 201, but now returns a status code of 200. This may create a compatibility issue, as a user may be reacting differently to different status codes.

In various examples, calls to a method may appear in one version of the API but not the other. For example, if the “setAge” method is present in the earlier version of the API but is removed for a later version, this may create a compatibility issue. This may be detected by the presence a call to “setAge” among the calls to the earlier version, but the absence of the call “setAge” among the calls to the later version.

In various examples, a parameter that was optional in an earlier version of an API may become mandatory. In comparing the calls, this may be noted by calls to the first API that do not include the parameter, while the calls to the second API consistently include the parameter.

In various examples, the number of parameters may change. This may be caused by the addition or the deletion of a parameter of a method in the second API. This compatibility issue may be indistinguishable from various other compatibility issues or even a scenario where no compatibility issue is present. For example, addition of a parameter may be indistinguishable from changing a parameter from optional to mandatory, especially if no observed calls to the first API provided the parameter. Deletion of a parameter may be indistinguishable from changing a parameter from mandatory to optional. While deletion of a parameter may be considered a compatibility issue, changing a parameter from mandatory to optional may not be. Various compatibility rules or checks may be selectively enabled, such as via a setting or command line parameter. This may allow a stricter test to provide an error or warning whenever the number of parameters change, to check for potential changes of parameters from optional to mandatory, or not to check a change in the number of parameters. The selective enablement of rules may be applied across the entire test or certain sets of interactions or calls may be excluded from certain checks.

In various examples, such as web applications, input headers and payload elements may be used. The input and output headers and payload elements may be compared like parameters. Changes in the presence or type of headers and payload elements may indicate a compatibility issue. A change in the request path used by a web application may also indicate a compatibility issue.

The sets of related interactions may be compared to identify differences between interactions, such as those discussed above, that suggest compatibility issues. If no compatibility issues are uncovered by the comparison, an indication may be provided regarding the compatibility. The indication may be storing the results in a file, displaying something on a monitor, or otherwise providing an indication of the results.

In various examples, the comparison may be checking for a specific kind of compatibility, such as backwards compatibility. For example, if the set of related interactions to the first API use two parameters for a “createContact” call, but the corresponding set of related interactions to the second API use either one or two parameters for “createContact,” that may indicate that both parameters are mandatory in the first API, but one is optional in the second API. If the first API is the newer API, this may indicate a backwards compatibility issue, as any users not supplying the optional parameter may not be able to use the first API without modifying their application. In this case, the newer API may be considered incompatible with the older API. In contrast, if the second API is the newer API, it may indicate a parameter was changed from being mandatory to optional. In this case, the newer API may be considered compatible with the older API.

In various examples, the indication may provide details about the compatibility. For example, the indication may provide the name of a function or method that has the compatibility issue. The indication may also provide information about the kind of compatibility issue that may be present. For example, it may indicate that a parameter type has changed, or that a status code is different. The indication may include the parameters and value used in making the calls, as well as any return values. This may prompt the application developer to investigate and determine the cause of the compatibility issue.

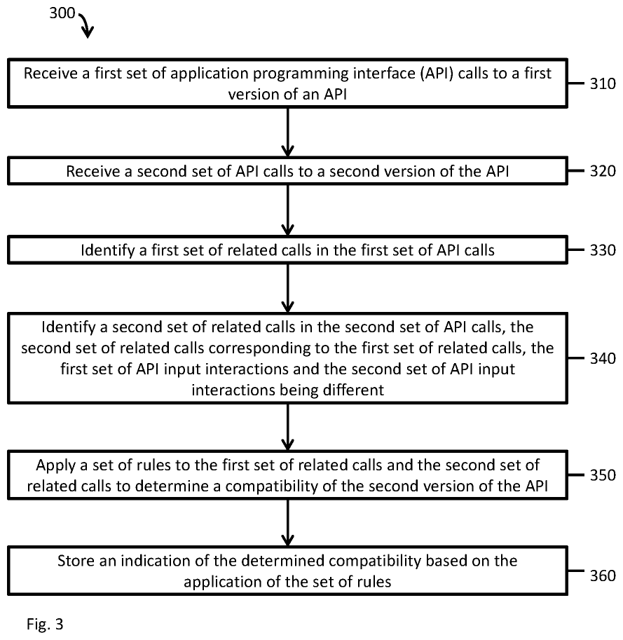

FIG. 3 shows a method 300 of applying a set of rules to identify related calls of versions of an API in accordance with various examples. The method 300 includes receiving a first set of application programming interface (API) calls to a first version of an API (310). The method 300 includes receiving a second set of API calls to a second version of the API (320). The method 300 includes identifying a first set of related calls in the first set of API calls (330). The method 300 includes identifying a second set of related calls in the second set of API calls, the second set of related calls corresponding to the first set of related calls, the first set of API input interactions and the second set of API input interactions being different (340). The method 300 includes applying a set of rules to the first set of related calls and the second set of related calls to determine a compatibility of the second version of the API (350). The method 300 includes storing an indication of the determined compatibility based on the application of the set of rules (360).

In various examples, the set of API calls may be received. For example, a HTTP proxy may be used to log the interactions with a web application. The data log may be a log file of the calls, responses, and parameters used with the calls and responses. The log file may also include internet addresses being used, as that may indicated the calls and responses are with different users. The log file may be received for compatibility analysis with another log file.

A set of rules may be applied to the sets of interactions to determine compatibility. For example, a rule may check that a set of related interactions with the first API has a corresponding set of related interactions with the second API. If no corresponding set of related interactions is found, it may indicate that functionality was removed and the second API is not backwards compatible with the first. Another rule may check to see if the parameter types are the same. The rules may also check the responses in determining compatibility. The rules may be used to identify specific potential compatibility issues. The indication may include what rule identified the compatibility issue.

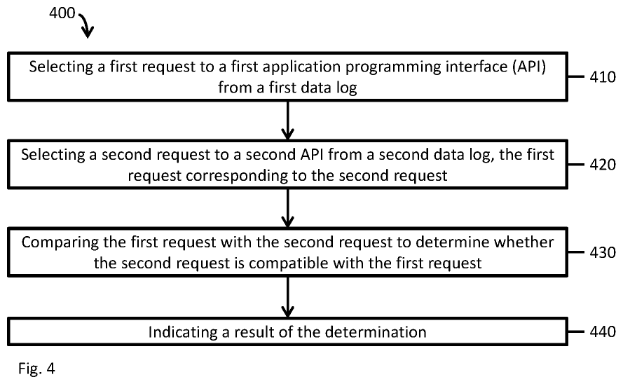

FIG. 4 shows a method 400 of selecting and comparing requests to APIs. The method 400 includes selecting a first request to a first application programming interface (API) from a first data log (410). The method 400 includes selecting a second request to a second API from a second data log, the first request corresponding to the second request (420). The method 400 includes comparing the first request with the second request to determine whether the second request is compatible with the first request (430). The method 400 includes indicating a result of the determination (440).

Comparing API interactions of actual use and testing may allow detection of compatibility issues without additional testing. The process may be automated and continually run in the background while development of an application or a new version of an application occurs. This may allow detecting compatibility issues as they are introduced in the development process. The issue may then be corrected, or it may be determined that the compatibility break is intentional. Using actual data from customer interactions with the API may also allow developers to determine the severity of any compatibility break. Changes in implementation may also be detected. Such changes may be detected by changes in status codes, return values, or by differences in similar sets of related interactions. By detecting the compatibility issues, there may be a decreased risk in developing and deploying software. Detecting the issues by an automated process early in development may decrease the time and costs involved with correcting the compatibility issue. In various examples, detection of a compatibility issue may prevent shipping or publishing a new version of an application until a waiver or approval is obtained.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A non-transitory computer-readable medium to store machine-readable instructions that, when executed by a processor, cause the processor to:
identify a first set of related interactions with a first application programming interface (API), the first set of related interactions including a first set of input interactions;
identify a second set of related interactions with a second API, the second set of related interactions including a second set of input interactions, the second set of related interactions corresponding to the first set of related interactions, the first set of input interactions and the second set of input interactions being different;
compare the first set of related interactions with the second set of related interactions to determine compatibility of the second API with the first API; and
indicate the determined compatibility based on the comparison.

2. The computer-readable medium of claim 1, wherein the comparison includes comparing an input parameter of the first set of related actions with an input parameter of the second set of related actions.

3. The computer-readable medium of claim 1, wherein the first set of related interactions are between a first computer system and a first user, the second set of related interactions are between a second computer system and a second user, the first user is different from the second user, and the first computer system is different from the second computer system.

4. The computer-readable medium of claim 1, wherein the first set of related interactions comprises hypertext transfer protocol (HTTP) requests.

5. The computer-readable medium of claim 1, wherein parameters of a first interaction from the first set of related interactions are different from parameters of a corresponding second interaction from the second set of related interactions, the comparison includes a comparison of the first interaction with the second interaction, and the determination includes that the second API is compatible with the first API.

6. A non-transitory computer-readable medium to store machine-readable instructions that, when executed by a processor, cause the processor to:
receive a first set of application programming interface (API) calls to a first version of an API;
receive a second set of API calls to a second version of the API;
identify a first set of related calls in the first set of API calls;
identify a second set of related calls in the second set of API calls, the second set of related calls corresponding to the first set of related calls, the first set of API input interactions and the second set of API input interactions being different;
apply a set of rules to the first set of related calls and the second set of related calls to determine a compatibility of the second version of the API; and
store an indication of the determined compatibility based on the application of the set of rules.

7. The computer-readable medium of claim 6, wherein receipt of a first set of API calls includes capturing the first set of API calls via a hypertext transfer protocol (HTTP) proxy.

8. The computer-readable medium of claim 6, wherein application of the set of rules includes application of the set of rules to a first set of responses and a second set of responses, the first set of responses being responses from the first version of the API to the first set of related calls, and the second set of responses being responses from the second version of the API to the second set of related calls.

9. The computer-readable medium of claim 8, wherein the indication of compatibility includes an identification of an API call with a compatibility issue.

10. The computer-readable medium of claim 8, wherein a first API call from the first set of related calls corresponds to a second API call from the second set of related calls, the first set of responses includes a first response to the first API call, the second set of responses includes a second response to the second API call, and application of the set of rules determines that the second API is incompatible with the first API based on a difference between the first response and the second response.

11. A method comprising:
selecting a first request to a first application programming interface (API) from a first data log;
selecting a second request to a second API from a second data log, the first request corresponding to the second request;
comparing the first request with the second request to determine whether the second request is compatible with the first request; and
indicating a result of the determination.

12. The method of claim 11 comprising:
selecting a first response from the first data log, the first response being in response to the first request;
selecting a second response from the second data log, the second response being in response to the second request;
comparing the first response with the second response to determine whether the second response is compatible with the first response; and
indicating a result of the determination of compatibility of the second response.

13. The method of claim 11, wherein the second API is a version of the first API.

14. The method of claim 11, wherein comparing includes applying a first rule to the first request and the second request and applying a second rule to the first request and the second request.

15. The method of claim 14, wherein indicating includes indicating the first rule based on a result of applying the first rule.
